(19) United States
(12) Patent Application Publication
(10) Pub. No.: US 2022/0203766 A1
(43) Pub. Date: Jun. 30, 2022

(54) NON-PNEUMATIC TIRE

(71) Applicant: Toyo Tire Corporation, Itami-shi (JP)

(72) Inventor: Hiroshi TAHARA, Itami-shi (JP)

(73) Assignee: Toyo Tire Corporation, Itami-shi (JP)

(21) Appl. No.: 17/551,891

(22) Filed: Dec. 15, 2021

(30) Foreign Application Priority Data
Dec. 28, 2020 (JP) 2020-219328

(51) Int. Cl. B60C 7/14; B60C 7/10

(52) U.S. Cl. CPC B60C 7/143; B60C 7/102

(57) ABSTRACT

A non-pneumatic tire includes: an outer annular portion; an inner annular portion; and a plurality of link parts. The plurality of link parts include first and second link parts. The first link parts each extend from one side in a tire width direction of the outer annular portion toward one other side in the tire width direction of the inner annular portion. The second link parts each extend from the other side in the tire width direction of the outer annular portion toward the one side in the tire width direction of the inner annular portion. The plurality of link parts each have a thickness which is smaller in the vicinity of the inner annular portion than in the vicinity of the outer annular portion and a width which is larger in the vicinity of the inner annular portion than in the vicinity of the outer annular portion.

This application is based on and claims the benefit of priority from Japanese Patent Application No. 2020-219328, filed on 28 Dec. 2020, the content of which is incorporated herein by reference.

### FIELD

The present invention relates to a non-pneumatic tire.

### BACKGROUND

In recent years, a non-pneumatic tire has been known for which the occurrence of punctures, etc. is not a problem (refer to, for example, Japanese Unexamined Patent Application, Publication No. 2017-218132). In general, a non-pneumatic tire has a structure in which a plurality of plate-shaped link parts arranged in the tire circumferential direction are connected between an outer annular portion and an inner annular portion provided concentrically inside the outer annular portion. The non-pneumatic tire deflects and deforms when subjected to a load from the vehicle by compressive force acting on the link parts provided in the contact area.

### SUMMARY

In such a non-pneumatic tire, the distance between link parts adjacent to each other in the tire circumferential direction is larger at the outer annular side and smaller at the inner annular side due to the circumferential length difference between the outer annular portion and the inner annular portion. Therefore, as the number of link parts increases, it becomes difficult to maintain the distance between adjacent link parts. On the other hand, when the link parts along the tire circumferential direction are made thinner on the inner annular portion side than on the outer annular portion side in order to maintain the distance between the adjacent link parts, the strength of the link parts differs between the connection sites with the outer annular portion and the connection sites with the inner annular portion, such that the durability of the link parts is lowered, and the link parts may break when the repeated stress while the tire is rolling is applied to the link parts. Therefore, conventional non-pneumatic tires address improving the strength of the connection sites between the inner annular portion and the link parts and improving the durability of the link parts while maintaining the distance between the adjacent link parts on the inner annular portion side.

The present invention has been made in view of the above problems, and an object thereof is to provide a non-pneumatic tire capable of improving the strength of connection sites between an inner annular portion and link parts, while maintaining a distance between adjacent link parts on an inner annular portion side, and improving the durability of the link parts.

Exemplary embodiments of the present invention provide a non-pneumatic tire including: an outer annular portion having an outer periphery including a tread provided thereon; an inner annular portion provided inside the outer annular portion; and a plurality of link parts that each connect the outer annular portion and the inner annular portion, and are provided along a tire circumferential direction, in which the plurality of link parts include first link parts and second link parts that are alternately provided along the tire circumferential direction, the first link parts each extending from one side in a tire width direction of the outer annular portion toward one other side in the tire width direction of the inner annular portion, the second link parts each extending from the other side in the tire width direction of the outer annular portion toward the one side in the tire width direction of the inner annular portion, in which the plurality of link parts each have a thickness in the tire circumferential direction which is smaller in a vicinity of the inner annular portion than in a vicinity of the outer annular portion, and in which the plurality of link parts each have a width in the tire width direction which is larger in the vicinity of the inner annular portion than in the vicinity of the outer annular portion.

According to an exemplary embodiment of the present invention, it is possible to provide a non-pneumatic tire capable of improving the strength of connection sites between an inner annular portion and link parts while maintaining a distance between adjacent link parts on an inner annular portion side, and improving the durability of the link parts.

### BRIEF DESCRIPTION OF THE DRAWINGS

FIG. 1 is a front view showing a non-pneumatic tire according to an exemplary embodiment of the present invention.

FIG. 2 is a cross-sectional view taken along the line A-A in FIG. 1.

FIG. 3 is a cross-sectional view taken along the line B-B in FIG. 2.

FIG. 4 is a diagram for explaining the thickness of a link part along a tire circumferential direction.

FIG. 5 is a cross-sectional view showing a link part of a non-pneumatic tire according to another exemplary embodiment of the present invention.

FIG. 6 is a cross-sectional view showing a link part of a non-pneumatic tire according to yet another exemplary embodiment of the present invention.

### DETAILED DESCRIPTION OF THE EMBODIMENTS

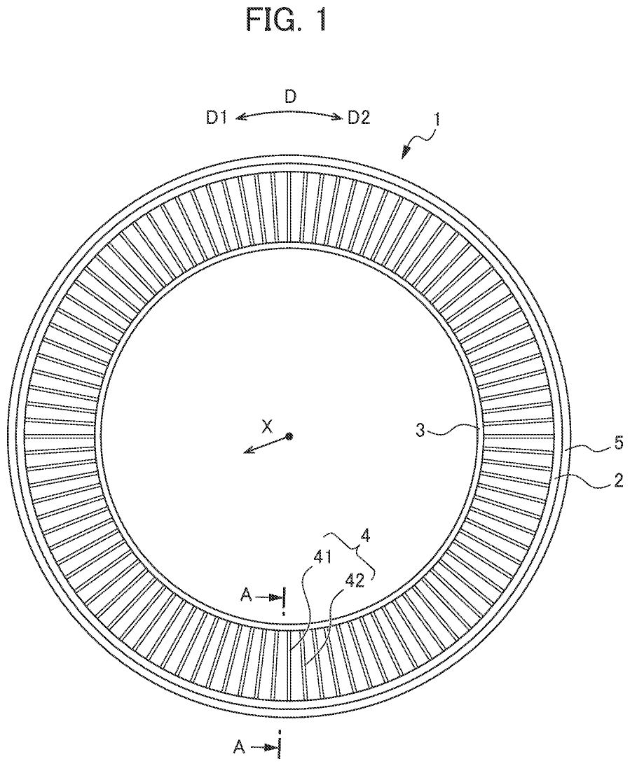

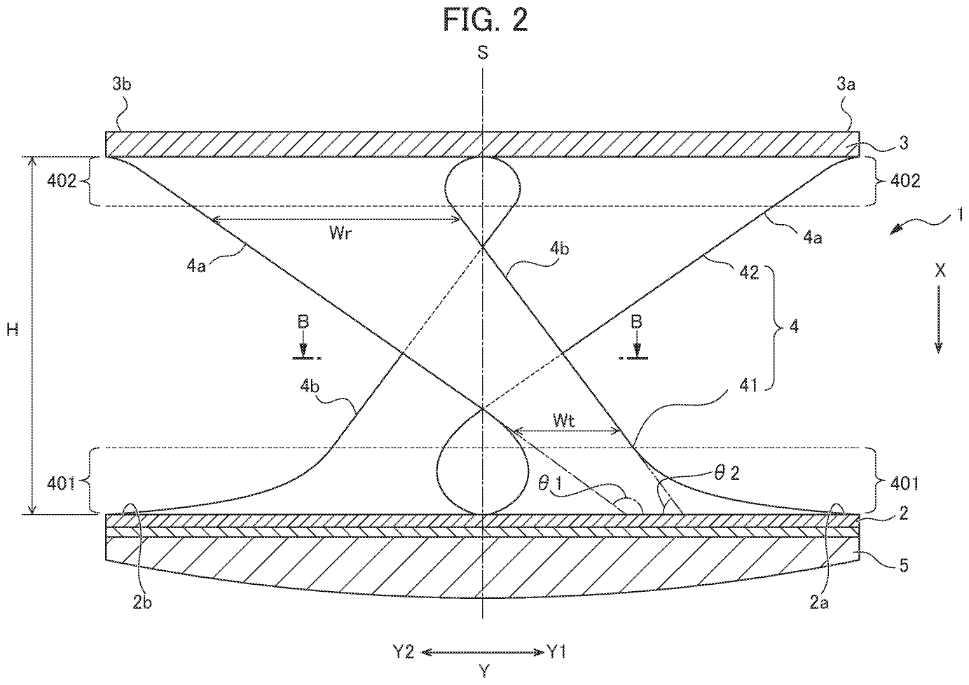

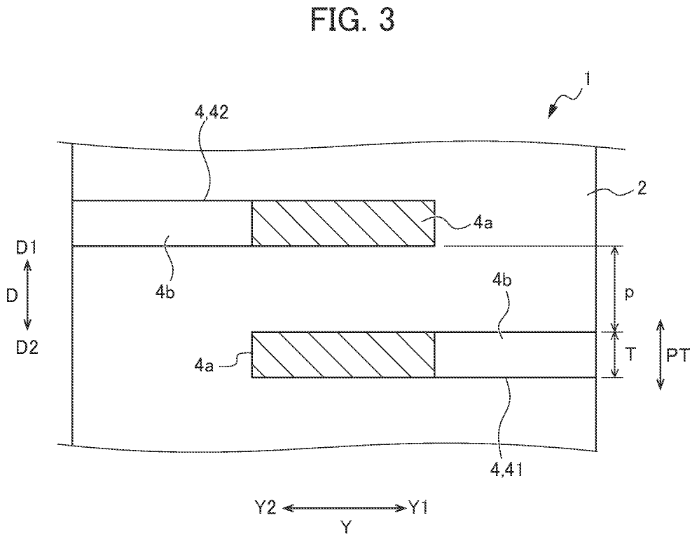

Exemplary embodiments of the present invention will be described below with reference to the drawings. FIG. 1 is a front view showing a non-pneumatic tire according to an exemplary embodiment of the present invention. FIG. 2 is a cross-sectional view taken along the line A-A in FIG. 1. FIG. 3 is a cross-sectional view taken along the line B-B in FIG. 2. A non-pneumatic tire 1 includes an outer annular portion 2, an inner annular portion 3 provided concentrically inside the outer annular portion 2, and a plurality of link parts 4 that each connect the outer annular portion 2 and the inner annular portion 3, and are provided independently along the tire circumferential direction D. The outer annular portion 2 has the outer periphery including a tread 5 provided thereon. The tread 5 is provided with a tread pattern similar to that of a conventional pneumatic tire.

First, the outer annular portion 2 and the inner annular portion 3 will be described. It should be noted that, in the following, the thicknesses of the outer annular portion 2 and the inner annular portion 3 each refer to the plate thickness in the direction along the tire radial direction X shown in FIGS. 1 and 2. The widths of the outer annular portion 2 and the inner annular portion 3 each refer to the width in the direction along the tire width direction Y shown in FIG. 2.

The outer annular portion 2 has a constant thickness in the circumferential direction and the width direction from the viewpoint of improving the uniformity. The thickness of the outer annular portion 2 is not particularly limited; however, from the viewpoint of reducing weight and improving durability while sufficiently transmitting the force from the link parts 4, it is preferable that the thickness of the outer annular portion 2 is 2% or more and 7% or less, and more preferably 2% or more and 5% or less, of the tire cross-sectional height H shown in FIG. 2.

The inner diameter of the outer annular portion 2 is appropriately determined in accordance with the application or the like. For example, when assuming substitution of general pneumatic tires, the inner diameter of the outer annular portion 2 may be 420 mm or more and 750 mm or less.

The width of the outer annular portion 2 is appropriately determined in accordance with the application or the like. For example, when assuming substitution of general pneumatic tires, the width of the outer annular portion 2 may be 100 mm or more and 300 mm or less.

The inner annular portion 3 has a constant thickness in the circumferential direction and the width direction from the viewpoint of improving the uniformity. Although not shown, the inner circumferential surface of the inner annular portion 3 may include irregularities or the like for retaining the fitting property for mounting with the axle and rim. The thickness of the inner annular portion 3 is not particularly limited; however, from the viewpoint of improving the weight reduction and durability while sufficiently transmitting a force to the link parts 4, it is preferable that the thickness of the inner annular portion 3 be 2% or more and 7% or less, and more preferably 3% or more and 6% or less, of the tire cross-sectional height H shown in FIG. 2.

The inner diameter of the inner annular portion 3 is appropriately determined in accordance with the dimensions and the like of the rim and the axle to which the non-pneumatic tire 1 is mounted. For example, when assuming the substitution of general pneumatic tires, the inner diameter of the inner annular portion 3 may be 250 mm or more and 500 mm or less.

The width of the inner annular portion 3 is appropriately determined according to the application, the length of the axle, and the like. For example, when assuming substitution of general pneumatic tires, the width of the inner annular portion 3 may be 100 mm or more and 300 mm or less.

The link parts 4 are each a member serving as a spoke in the non-pneumatic tire 1 and connecting the outer annular portion 2 and the inner annular portion 3 so as to maintain a constant interval. The plurality of link parts 4 are independently arranged at regular intervals along the tire circumferential direction D. As shown in FIG. 1, the plurality of link parts 4 extend linearly in the radial direction along the tire radial direction X when the non-pneumatic tire 1 is viewed in the unloaded state from the front direction along the tire rotation axis.

The link part 4 is made of an elastic material. Elastic material refers to, for example, a material in which tensile modulus calculated from the tensile stress at 10% elongation is 100 MPa or less when subjected to a tensile test in accordance with JIS K7321. More specifically, from the viewpoint of imparting moderate stiffness while maintaining adequate durability, it is preferable that the tensile modulus is 5 MPa or more and 100 MPa or less, and more preferably 7 MPa or more and 50 MPa or less.

Examples of the elastic material used as the base material of the link part 4 include thermoplastic elastomers, crosslinked rubbers, and other resins.

Examples of the thermoplastic elastomer include polyester elastomer, polyolefin elastomer, polyamide elastomer, polystyrene elastomer, polyvinyl chloride elastomer, and polyurethane elastomer.

As the rubber material constituting the crosslinked rubber, any natural rubber and synthetic rubber can be used. Examples of the synthetic rubber include styrene butadiene rubber (SBR), butadiene rubber (BR), isoprene rubber (IIR), nitrile rubber (NBR), hydrogenated nitrile rubber (hydrogenated NBR), chloroprene rubber (CR), ethylene propylene rubber (EPDM), fluororubber, silicon rubber, acrylic rubber, and urethane rubber. Two or more of these rubber materials may be used in combination if necessary.

Examples of other resins include thermoplastic resins and thermosetting resins. Examples of the thermoplastic resin include polyethylene resins, polystyrene resins, and polyvinyl chloride resins. The thermosetting resins include, for example, epoxy resins, phenolic resins, polyurethane resins, silicon resins, polyimide resins, and melamine resins.

Among the above-mentioned elastic materials, a polyurethane resin is preferably used for the link parts 4 from the viewpoint of molding, processability and cost. It should be noted that a foam material can also be used as the elastic material. In other words, those obtained by foaming the above-mentioned thermoplastic elastomer, crosslinked rubber, or other resins can be used. Furthermore, when the outer annular portion 2 and the inner annular portion 3 are made of resin, the link parts 4 may be formed integrally with the outer annular portion 2 and the inner annular portion 3 using the same resin material.

The plurality of link parts 4 are configured such that a first link part 41 and a second link part 42 are alternately arranged along the tire circumferential direction D. As shown in FIG. 2, the first link part 41 extends from one side Y1 in the tire width direction Y of the outer annular portion 2 toward the other side Y2 in the tire width direction Y of the inner annular portion 3. The second link part 42 extends from the other side Y2 in the tire width direction Y of the outer annular portion 2 toward the one side Y1 in the tire width direction Y of the inner annular portion 3. The first link part 41 and the second link part 42 adjacent to each other in the tire circumferential direction D are arranged so as to intersect in a substantially X-shape, when viewed in the tire circumferential direction D. The first link part 41 and the second link part 42 as viewed in the tire radial direction X are parallel or substantially parallel to the tire width direction Y, and extend in a direction perpendicular or substantially perpendicular to the tire equatorial plane S.

As shown in FIG. 2, the first link part 41 and the second link part 42 as viewed from the tire circumferential direction D have the same shape, and are symmetrical with respect to the tire equatorial plane S. Therefore, the specific shape of each link part 4 will be described using the first link part 41. It should be noted that the tire equatorial plane S refers to a plane perpendicular or substantially perpendicular to the tire rotation axis (tire meridian), and a plane located at the center in the tire width direction Y.

The link part 4 has an elongated plate shape extending obliquely toward the inner annular portion 3 from the outer annular portion 2. As shown in FIGS. 2 and 3, the link part 4 has a plate width W (Wr, Wt) which is smaller than the plate thickness T, and the plate thickness direction PT is along the tire circumferential direction D. That is, the link part 4 has a plate shape extending in the tire radial direction X and the tire width direction Y. It should be noted that the plate thickness T of the link part 4 refers to the thickness of the link part 4 along the tire circumferential direction D. The plate width W of the link part 4 refers to a width of the link part 4 in the direction along the tire width direction Y. The link part 4 has such an elongated plate shape that, even in a case of a thin plate thickness T, it is still possible to improve the durability of the link part 4 having the thin plate thickness T by setting a wide plate width W. Furthermore, by increasing the number of the first link parts 41 and the second link parts 42 while reducing the plate thickness T, it is possible to reduce the gap between the link parts 4 and 4 adjacent to each other in the tire circumferential direction D while maintaining the rigidity of the entire tire. This makes it possible to reduce the ground pressure dispersion while the tire is rolling. Further detailed configuration of the plate thickness T and the plate width W of the link part 4 will be described later.

As shown in FIG. 2, the link part 4 has a shape in which a connecting portion 401 with the outer annular portion 2 and a connecting portion 402 with the inner annular portion 3 gently spread along the tire width direction Y, respectively. The connecting portion 401 with the outer annular portion 2 of the first link part 41 is provided over a half area of the outer annular portion 2 in the tire width direction.

That is, the one side Y1 of the connecting portion 401 of the first link part 41 extends to an end portion 2a of the one side Y1 of the outer annular portion 2. The other side Y2 of the connecting portion 401 of the first link part 41 extends to the tire equatorial plane S disposed in the middle of the outer annular portion 2 in the tire width direction. The other side Y2 of the connecting portion 401 of the first link part 41 extends to an end portion 3b of the other side Y2 of the inner annular portion 3. The one side Y1 of the connecting portion 402 of the first link part 41 extends to the tire equatorial plane S disposed in the middle of the inner annular portion 3 in the tire width direction.

Similarly, the other side Y2 of the connecting portion 401 of the second link part 42 extends to an end portion 2b of the other side Y2 of the outer annular portion 2. The one side Y1 of the connecting portion 401 of the second link part 42 extends to the tire equatorial plane S disposed in the middle of the outer annular portion 2 in the tire width direction. The one side Y1 of the connecting portion 402 of the second link part 42 extends to an end portion 3a of the one side Y1 of the inner annular portion 3. The other side Y2 of the connecting portion 402 of the second link part 42 extends to the tire equatorial plane S disposed in the middle of the tire width direction of the inner annular portion 3.

The pitch p between the first link part 41 and the second link part 42 adjacent to each other in the tire circumferential direction D is preferably constant and small in the tire circumferential direction D. More specifically, the pitch p is preferably 1 mm or more and 10 mm or less, and more preferably 1 mm or more and 5 mm or less. When the pitch p is greater than 10 mm, the ground pressure tends to become uneven in the tire circumferential direction D, and the vehicle external sound may be generated.

The number of the link parts 4 provided in the non-pneumatic tire 1 is preferably 80 or more and 300 or less, and more preferably 100 or more and 200 or less from the viewpoint of the improvement in weight reduction, power transmission, and durability while sufficiently supporting the load from the vehicle. FIG. 1 shows an example in which 50 pieces of first link parts 41 and 50 pieces of second link parts 42 are provided.

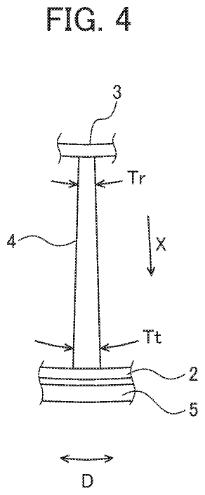

As shown in FIG. 4, the plate thickness T of the link part 4 differs between in the vicinity of the outer annular portion 2 and in the vicinity of the inner annular portion 3. More specifically, the plate thickness T of the link part 4 is smaller toward the inner annular portion 3 of the plate thickness Tr than the plate thickness Tt of the outer annular portion 2. Therefore, even when the plate thickness of the link part 4 becomes large as a whole, or even when increasing the number of link parts 4 along the tire circumferential direction D, it is possible to maintain the distance between the link parts 4 and 4 adjacent to each other in the tire circumferential direction D in the inner annular portion 3. The plate thicknesses Tt and Tr are not limited specifically; however, for example, the plate thickness Tt of the link part 4 in the vicinity of the outer annular portion 2 may be, for example, 18% or more and 22% or less of the tire cross-sectional height H, and the plate thickness Tr in the vicinity of the inner annular portion 3 of the link part 4 may be, for example, 13% or more and 17% or less of the tire cross-sectional height H.

As shown in FIG. 2, the plate width W of the link part 4 differs between the vicinity of the outer annular portion 2 and the vicinity of the inner annular portion 3. More specifically, in relation to the plate width W of the link part 4, the plate width Wr in the vicinity of the inner annular portion 3 is larger than the plate width Wt in the vicinity of the outer annular portion 2. Therefore, even when the plate thickness Tr in the vicinity of the inner annular portion 3 is smaller than the plate thickness Tt in the vicinity of the outer annular portion 2, it is still possible to reduce the difference in the respective cross-sectional areas when the link part 4 is cut in a plane perpendicular or substantially perpendicular to the tire radial direction X in the vicinity of the outer annular portion 2 and in the vicinity of the inner annular portion 3. This makes it possible to improve the strength of the connection sites between the inner annular portion 3 and the link part 4 in the vicinity of the inner annular portion 3 at which the plate thickness Tr becomes small, and to improve the durability of the link part 4.

It should be noted that the plate width Wt in the vicinity of the outer annular portion 2 and the plate width Wr in the vicinity of the inner annular portion 3 of the link part 4 each refer to a plate width of the portion to be deflected, and refer to a plate width at a position as close as possible to the outer annular portion 2 and the inner annular portion 3 when a load is applied to the link part 4. As shown in FIG. 2, when the connecting portion 401 between the link part 4 and the outer annular portion 2, and the connecting portion 402 between the link part 4 and the inner annular portion 3 each have a shape extending in the tire width direction Y, the plate width Wt in the vicinity of the outer annular portion 2 of the link part 4 is located closer to the inner annular portion 3 than the connecting portion 401, and refers to a portion adjacent to the connecting portion 401. This portion is located in the vicinity of the outer annular portion 2 relative to the position which is half of the tire cross-sectional height H. Furthermore, the plate width Wr of the link part 4 in the vicinity of the inner annular portion 3 is located closer to the outer annular portion 2 than the connecting portion 402, and refers to a width of a portion adjacent to the connecting portion 402. This portion is located in the vicinity of the inner annular portion 3 relative to the position which is half of the tire cross-sectional height H.

The plate width W of the link part 4 shown in FIG. 2 gradually increases toward the inner annular portion 3 from the outer annular portion 2. More specifically, an inner line 4a and an outer line 4b in the tire width direction Y in the link part 4 are provided so as to extend in the tire width direction Y at a constant ratio from the vicinity of the connecting portion 401 with the outer annular portion 2 toward the vicinity of the connecting portion 402 with the inner annular portion 3. With such a configuration, it is possible to make the cross-sectional area of the link part 4 substantially uniform over the entire tire cross-sectional height H.

It should be noted that, when viewing the link part 4 extending obliquely from the outer annular portion 2 toward the inner annular portion 3 in the tire circumferential direction D, as shown in FIG. 2, the inner line 4a is defined as a line making the intersection angle θ1 between the outer annular portion 2 and the inner line 4a to be an obtuse angle, and the outer line 4b is defined as a line making the intersection angle θ2 between the outer annular portion 2 and the outer line 4b to be an acute angle. Therefore, in the first link part 41 shown in FIG. 2, the inner line 4a is a line of the other side Y2 in the tire width direction Y, and the outer line 4b is a line of the one side Y1 in the tire width direction Y. In the second link part 42, the inner line 4a is a line of the one side Y1 in the tire width direction Y, and the outer line 4b is a line of the other side Y2 in the tire width direction Y.

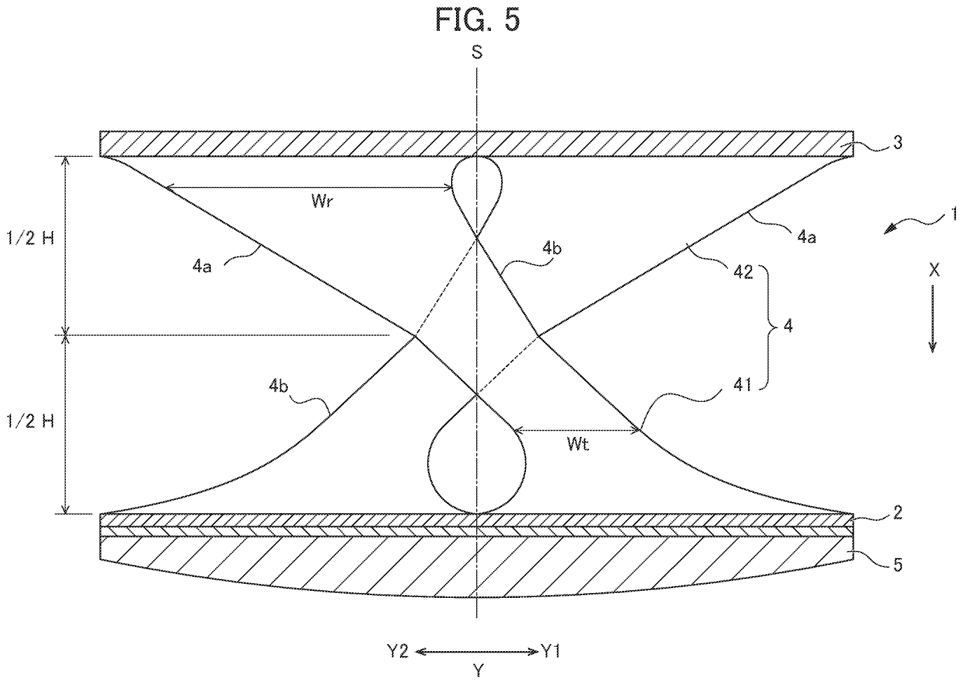

As shown in FIG. 5, the plate width W of the link part 4 may gradually increase from the middle portion in the tire radial direction X in the link part 4 toward the inner annular portion 3. In the link part 4 shown in FIG. 5, while the plate width Wt in the vicinity of the outer annular portion 2 with respect to the position which is half of the tire cross-sectional height H is a constant width, the plate width Wr in the vicinity of the inner annular portion 3 with respect to the position which is half of the tire cross-sectional height H increases toward the inner annular portion 3 with respect to the position which is half of the tire cross-sectional height H. With such a configuration, it is possible to prevent breakage of the link part 4 in the vicinity of the inner annular portion 3 without impairing the ease of deformation of the link part 4 in the vicinity of the outer annular portion 2.

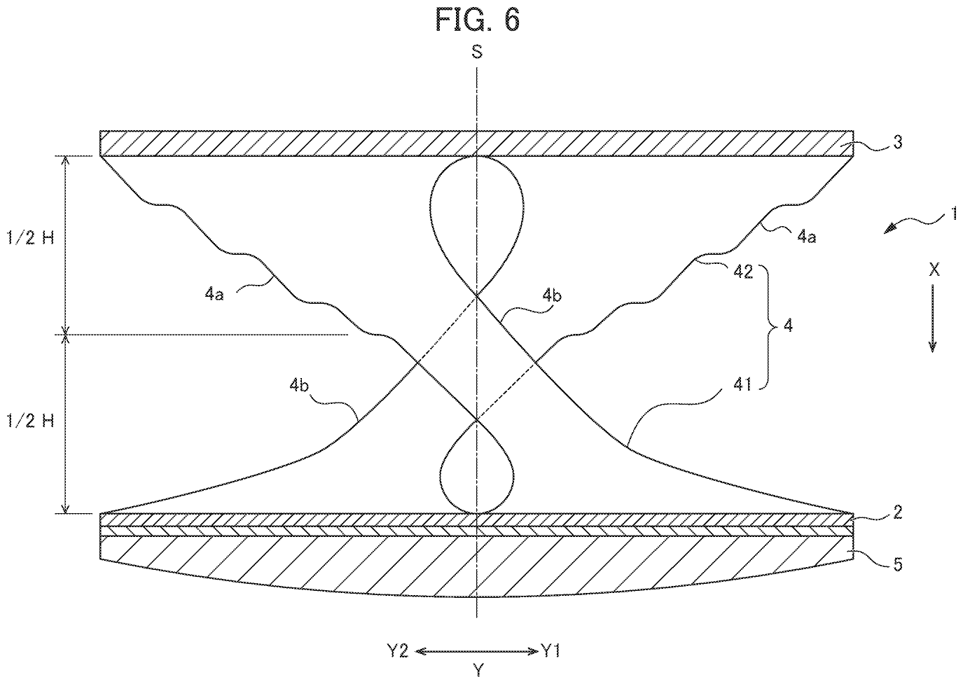

As shown in FIG. 6, the plate width W of the link part 4 may gradually increase from the vicinity of the outer annular portion 2 toward the vicinity of the inner annular portion 3. In the link part 4 shown in FIG. 6, by only the inner line 4a in the vicinity of the inner annular portion 3 being formed in a stepped shape with respect to the position which is half of the tire cross-sectional height H, the plate width Wr of the link part 4 in the vicinity of the inner annular portion 3 increases stepwise. However, the outer line 4b may also be formed in a stepped manner. In addition, the plate width W of the link part 4 may increase in a stepwise manner by forming the inner line 4a and the outer line 4b of the link part 4 in a stepwise manner over the entire tire cross-sectional height H.

It should be noted that the method of increasing the plate width Wr of the link part 4 in the vicinity of the inner annular portion 3 is not limited to those for changing the angle and shape of both the inner line 4a and the outer line 4b of the link part 4, and may change the angle and shape of only one of the inner line 4a and the outer line 4b. For example, in FIG. 6, by the inner line 4a being formed in a stepped shape without changing the shape of the outer line 4b of the link part 4, the plate width Wr of the link part 4 in the vicinity of the inner annular portion 3 is formed larger. On the contrary, the plate width Wr of the link part 4 in the vicinity of the inner annular portion 3 may be formed to be large without changing the shape of the inner line 4a of the link part 4.

According to the non-pneumatic tire 1 of the present exemplary embodiments, the following advantageous effects are obtained.

(1) The non-pneumatic tire 1 according to one of the present exemplary embodiments includes: the outer annular portion 2 having an outer periphery including the tread 5 provided thereon; the inner annular portion 3 provided inside the outer annular portion 2; and the plurality of link parts 4 that each connect the outer annular portion 2 and the inner annular portion 3, and are provided along the tire circumferential direction D. The plurality of link parts 4 include the first link parts 41 and the second link parts 42 that are alternately provided along the tire circumferential direction D. The first link parts 41 each extend from one side Y1 in the tire width direction Y of the outer annular portion 2 toward the other side Y2 in the tire width direction Y of the inner annular portion 3. The second link parts 42 each extend from the other side Y2 in the tire width direction Y of the outer annular portion 2 toward the one side Y1 in the tire width direction Y of the inner annular portion 3. The plurality of link parts 4 each have the thickness T in the tire circumferential direction D which is smaller in the vicinity of the inner annular portion 3 than in the vicinity of the outer annular portion 2. The plurality of link parts 4 each have the width W in the tire width direction Y which is larger in the vicinity of the inner annular portion 3 than in the vicinity of the outer annular portion 2. With such a configuration, it is possible to maintain the distance between the link parts 4 and 4 adjacent to each other in the vicinity of the inner annular portion 3 in the tire circumferential direction D, even when the plate thickness T of the link part 4 increases as a whole, or the number of link parts 4 along the tire circumferential direction D increases. Furthermore, even when the plate thickness Tr in the vicinity of the inner annular portion 3 is smaller than the plate thickness Tt in the vicinity of the outer annular portion 2, it is still possible to reduce the difference in the respective cross-sectional areas when the link part 4 is cut in a plane perpendicular or substantially perpendicular to the tire radial direction X in the vicinity of the outer annular portion 2 and in the vicinity of the inner annular portion 3. This makes it possible to improve the strength of the connection sites between the inner annular portion 3 and the link part 4 at which the plate thickness Tr becomes small, and to improve the durability of the link part 4.

(2) In the non-pneumatic tire 1 according to one of the present exemplary embodiments, the plurality of link parts 4 may each have the width W in the tire width direction Y which increases gradually or in a stepwise manner from the vicinity of the outer annular portion 2 toward the vicinity of the inner annular portion 3. With such a configuration, it is possible to make the cross-sectional area of the link part 4 substantially uniform over the entire tire cross-sectional height H.

(3) In the non-pneumatic tire 1 according to one of the present exemplary embodiments, the plurality of link parts 4 may each have the width W in the tire width direction Y which increases gradually or in a stepwise manner from a middle portion of the link part 4 in the tire radial direction X toward the vicinity of the inner annular portion 3, and is constant from the middle portion toward the vicinity of the outer annular portion 2. With such a configuration, it is possible to prevent breakage of the link parts 4 in the vicinity of the inner annular portion 3 without impairing the ease of deformation of the link parts 4 in the vicinity of the outer annular portion 2.

What is claimed is:

1. A non-pneumatic tire, comprising:
an outer annular portion having an outer periphery including a tread provided thereon;
an inner annular portion provided inside the outer annular portion; and
a plurality of link parts that each connect the outer annular portion and the inner annular portion, and are provided along a tire circumferential direction,
wherein the plurality of link parts include first link parts and second link parts that are alternately provided along the tire circumferential direction, the first link parts each extending from one side in a tire width direction of the outer annular portion toward one other side in the tire width direction of the inner annular portion, the second link parts each extending from the other side in the tire width direction of the outer annular portion toward the one side in the tire width direction of the inner annular portion,
wherein the plurality of link parts each have a thickness in the tire circumferential direction which is smaller in a vicinity of the inner annular portion than in a vicinity of the outer annular portion, and
wherein the plurality of link parts each have a width in the tire width direction which is larger in the vicinity of the inner annular portion than in the vicinity of the outer annular portion.

2. The non-pneumatic tire according to claim 1, wherein the plurality of link parts each have a width in the tire width direction which increases gradually or increases in a stepwise manner from the vicinity of the outer annular portion toward the vicinity of the inner annular portion.

3. The non-pneumatic tire according to claim 1, wherein the plurality of link parts each have a width in the tire width direction which increases gradually or increases in a stepwise manner from a middle portion of the link part in the tire radial direction toward the vicinity of the inner annular portion, and is constant from the middle portion toward the vicinity of the outer annular portion.
